(19) United States
(12) Patent Application Publication
(10) Pub. No.: US 2005/0177604 A1
(43) Pub. Date: Aug. 11, 2005

(54) Generation of a signal corresponding to value units in relation to a comparison of comparison values

(76) Inventor: Jonas Naslund, Jarfalla (SE)

Correspondence Address: Steven S. Payne;Suite 1005, 1101 17th Street, N.W., Washington, DC, 20036, US

(21) Appl. No.: 11/000,900

(22) Filed: Dec. 2, 2004

(30) Foreign Application Priority Data
Feb. 9, 2004 (SE) 0400266-3

(51) Int. Cl. G06F 3/00

(52) U.S. Cl. 708/200

(57) ABSTRACT

According to the invention a device has a calculation unit distributing value units into a first and a second group, setting a first counter value and performing comparison value dependent calculations. In these calculations it receives a selection of all value units in the first group or one value unit in the second group, compares at least two comparison values with each other and increases the number of value units in the first group if the user has selected all the value units therein or in another group if the user has selected one value unit in case the comparison is in favor of the user, or otherwise removes all selected value units. The calculation unit repeats the calculations and changes the counter value each time calculations are performed for only one value unit, and otherwise resets the first counter value and automatically selects all value units in the first group in the calculations if the counter value has reached a second counter value.

### TECHNICAL FIELD

The present invention relates to the area of gaming machines and Internet based games and more particularly to a device, a method and a computer program product for generating a signal corresponding to value units in relation to a comparison of comparison values.

### BACKGROUND OF THE INVENTION

Within the field of gaming machines and Internet based games it is known to offer a user the possibility to play different types of card games, for instance poker. One such device is described in WO-02/070089, where for the purpose of keeping a user tied to a game, he is offered a number of different winning events, where a winning event is also called a jackpot, which can be reached in a not too distant future. In this way the user is provided with the possibility to see when a high prize can possibly be paid out.

One problem with such games is that the user can seldom decide when he is to place a high stake or a minimal stake. At the same time it is important that the operator of the game shall be guaranteed an advantageous margin of profit.

### SUMMARY OF THE INVENTION

The present invention is directed towards enabling, for a gaming device based on comparing different comparison values, for instance in the form of digital cards, a higher degree of freedom for a user to vary his stakes while at the same time allowing the gaming operator to have a reasonable margin of profit.

This object is according to the present invention achieved through a method of generating a signal corresponding to at least one value unit in relation to a performed comparison of a number of comparison values comprising the steps of:
receiving an input signal corresponding to a number of value units from a user,
distributing the value units into at least a first and a second group,
setting a first pre-determined counter value,
performing comparison value dependent calculations, and
generating an output signal to the user corresponding to obtained value units in dependence of the result in said step of performing comparison value dependent calculations,
   wherein the step of performing comparisons value dependent calculations comprises the further steps of:
receiving a selection of all the value units in said first group or one value unit primarily from the second group,
comparing at least two comparison values with each other, and
increasing the number of value units in said first group if the user has selected the value units therein or of the value units in another group if the user has selected one value unit in case the comparison is in favor of the user, or
removing all selected value units in case the comparison is not in favor of the user,
   wherein the method furthermore comprises the further steps of:
repeating the step of performing comparison value dependent calculations,
changing the counter value each time the step of comparison value dependent calculations is performed for only one value unit, and otherwise resetting said counter value, and
automatically selecting all value units in said first group in the step of performing comparison value dependent calculations if the counter value has reached a second pre-determined counter value.

This object is furthermore achieved by a device for generating a signal corresponding to at least one value unit in relation to a performed comparison of a number of comparison values comprising:
an input unit for receiving an input signal corresponding to a number of value units from a user,
an output unit for generating an output signal to the user corresponding to a number of obtained value units in dependence of comparison value dependent calculations, and
a calculating unit for distributing the value units into at least a first and a second group, for setting a first pre-determined counter value and for performing comparison value dependent calculations,
which, when performing comparison value dependent calculations, is arranged to:
   receive a selection of all the value units in said first group or one value unit primarily from the second group,
   compare at least two comparison values with each other, and
   increase the number of value units in said first group if the user has selected the value units therein or of the value units in another group if the user has selected at least one value unit in case the comparison is in favor of the user, or
   remove all selected value units in case the comparison is not in favor of the user,
wherein said calculating unit is further arranged to:
   repeat the performing of comparison value dependent calculations,
change the counter value each time comparison value dependent calculations are performed for only one value unit and otherwise reset said first pre-determined counter value, and
   automatically select all value units in said first group when performing comparison value dependent calculations if the counter value has reached a second pre-determined counter value.

This object is also achieved by a computer program product for generating a signal corresponding to at least one value unit in relation to a performed comparison of a number of comparison values, comprising computer program code for, when said code is loaded into a computer, make said computer do:
enable reception of an input signal corresponding to a number of value units from a user,
distribute the value units into at least a first and a second group,
set a first pre-determined counter value,
perform comparison value dependent calculations, and
generate an output signal to the user corresponding to a number of obtained value units in dependence of the result when performing comparison value dependent calculations,
wherein said computer when performing said comparison value calculations causes:
   enabling reception of a selection of all the value units in said first group or one value unit primarily from the second group,
   comparing at least two comparison values with each other, and
   increasing the number of value units in said first group if the user has selected the value units therein or the value units in another group if the user has selected at least one value unit in case the comparison is in favor of the user, or
   removing all selected value units in case the comparison is not in favor of the user,
wherein said computer when performing comparison value dependent calculations furthermore causes:
   repeating the performing of comparison value dependent calculations,
   changing the counter value each time comparison value dependent calculations are performed for only one value unit, and otherwise resetting said first pre-determined counter value, and
   automatically selecting all value units in said first group when performing comparison value dependent calculations if the counter value has reached a second pre-determined counter value.

The invention has the following advantages. It provides a game where a user gets a reasonable chance of evaluating his stake and when he is to choose to wager it while at the same time ensuring that a gaming operator receives a reliable profit-margin. The game is furthermore very simple in its construction and can thus be immediately grasped without any complicated learning measures.

### BRIEF DESCRIPTION OF DRAWINGS

The present invention will in the following be described in more detail with reference being made to the accompanying drawings, where

FIG. 1 shows a device according to the invention in the form of a gaming machine,

FIG. 2 shows a block schematic of the different units that cooperate within the gaming machine,

FIG. 3 shows the device according to the invention in the form of a server that a user communicates with via his own computer and the Internet,

FIG. 4A shows a first part of a flow chart of a method according to the invention,

FIG. 4B shows a second part of a flow chart of a method according to the invention, and

FIG. 5 shows a computer program product according to the invention in the form of a CD ROM disc on which program code is provided for performing the method according to the invention.

### DESCRIPTION OF EMBODIMENT

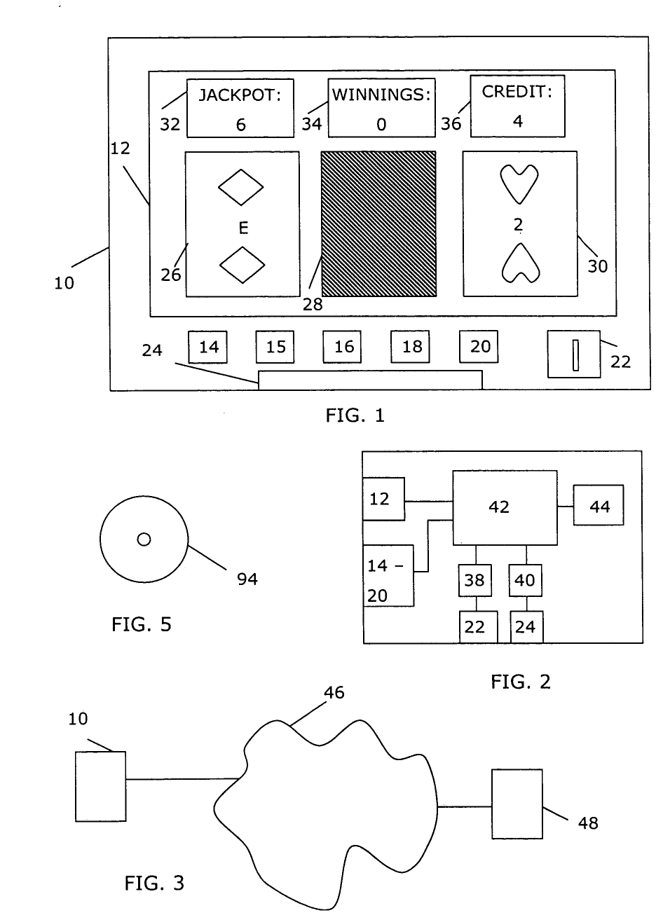

FIG. 1 schematically shows a gaming device 10 according to a first embodiment of the present invention. The gaming device comprises a display 12 and a number of data input means in the form of a first button 14, a second button 15, a third button 16, a fourth button 18 and a fifth button 20. The device 10 also comprises a value unit receiver 22 as well as a value unit returner 24. On the display there is shown a first 26 and a second 30 playing card, where the value of the card is visible, while a third card 28 that is turned with its back side upwards is placed between the first 26 and the second 30 card. The value of the third card is thus not visible in this view. The first card is the ace of diamonds, while the second card is two of hearts. There is furthermore shown three fields above the cards on the display 12. These fields include a first field 32 that includes the information jackpot 16, a second field 36 that includes the information credit: 4 as well as a third field 34 that includes the information winnings: 0. The meaning of these cards and fields will shortly be described in more detail later in this description.

FIG. 2 shows a block schematic of the device in FIG. 1. For the sake of simplicity the buttons 14-20 have here been combined into one single tactile data input means that communicates with a calculating unit 42. Also the display 12 is communication with this calculating unit 42, which thus controls which information that is to be displayed on the display 12. The value unit receiver 22 is in contact with a unit 38 for conversion of physical value unit to electronic value unit, while the value unit returner 24 is in contact with a unit 40 for conversion of electronic value unit to physical value unit. The unit 38 provides an input unit for reception of input signals representing a number of value units, while the unit 40 represents an output unit for generation of an output signal corresponding to a number of received value units. Both these units 38 and 40 are also connected to the calculating unit 42. The calculating unit 42 is also communicating with a deck of cards memory 44.

FIG. 3 shows yet a variation of the device 10 according to the invention. In this embodiment the device is provided as a server 10, with which a user gets in contact via his computer 48 using an Internet connection via the Internet 46. In this case the device would essentially include the calculating unit and the deck of cards memory. The display and the tactile data input means would then be provided in the computer 48 of the user. Input and return of value units should then also be provided in the computer of the user. Thus value units should here also be transmitted between the computer 48 of the user and the server 10 using electronic signals. It should here also be mentioned that this solution is not limited to the Internet but can also be applied in other types of networks, like for instance cellular networks. The whole or parts of the network 46 can thus be a wireless telecommunication network.

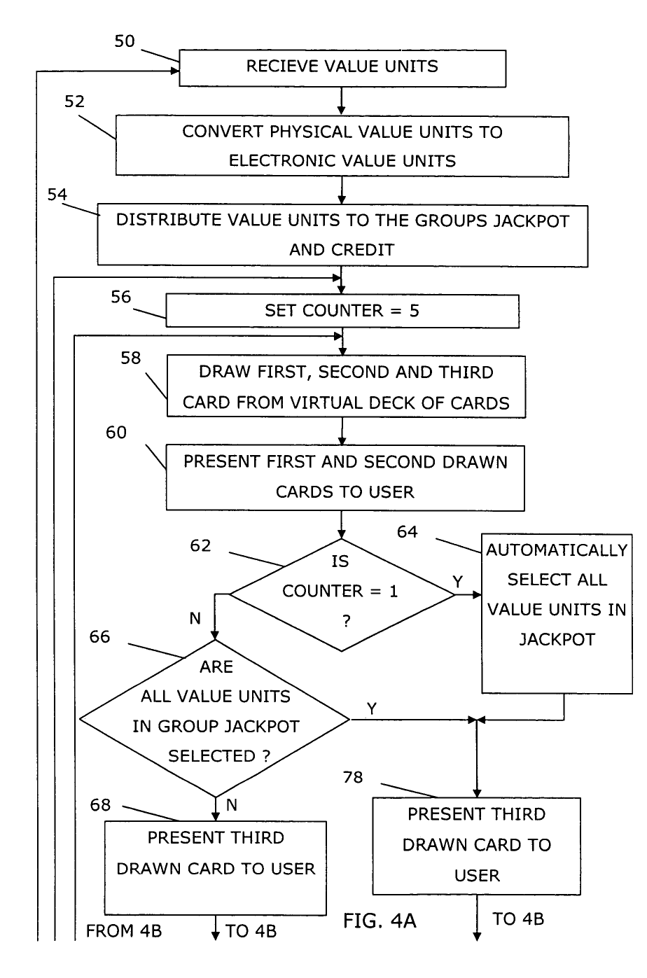

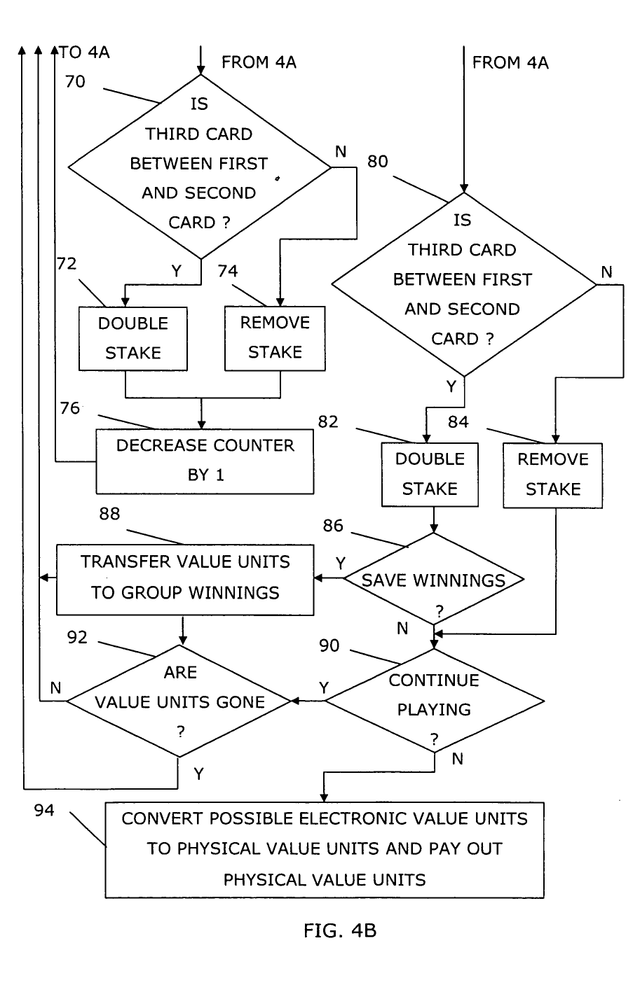

The preferred embodiment of the present invention will now be described in more detail with reference being made to FIGS. 1, 2 and 4, where the latter shows a flow chart of a method that the device in FIGS. 1 and 2 is working according to.

Before the actual method is started, the calculating unit 42 generates a set with a pre-determined number of fixed comparison values that have a number of different discrete levels. There can be several comparison values that have the same discrete level, for instance four values that have the same level. In this embodiment of the invention the set is a virtual deck of cards, where there thus are 13 different discrete levels and four comparison values at each discrete level. In FIG. 1 there is shown two such values 26 and 30. The set is furthermore provided with a comparison value having a varying level, which value in the deck of cards is represented by a joker. These values are stored in the deck of cards memory 44. The method starts when a user or player wants to start playing a game that the device offers. The player then enters value units and in this embodiment in the form of coins in the value unit receiver 22, which thus receives value units, step 50. In this embodiment it receives value units in an amount of 10, for instance 10 SEK in the form of a coin. These physical value units are then converted in the unit 38 to electronic value units corresponding to the same amount, step 52. These electronic value units are then sent to the calculating unit 42, which distributes the value units into a first group jackpot and a second group credit, step 54. In this example the group jackpot receives 6 value units, as is shown in the first field 32, and the group credit 4 value units, as is shown in the second field 36. The calculating unit 42 also makes sure that this information is also displayed on the display 12.

When the calculating unit 42 has distributed the value units it can start and perform a number of comparison value dependent calculations. It starts by setting a counter to a first pre-determined value, which value is here 5, step 56. This value represents a pre-determined number of turns that correspond to the paid value units. Thereafter a first 26, a second 30 and a third 28 card is drawn randomly from the virtual deck of cards, step 58, where the calculating unit 42 controls the display 12 to present the first 26 and the second 30 card to the user, step 60. The first card 26 is in this example the ace of diamonds and the second card 30 is 2 of hearts. At the same time the third card 28 is kept hidden. The calculating unit then investigates if the counter has the value 1, step 62, and if does not have this, the user has the possibility to select how he is to wager his value units. He can then choose to bet all value units in the group jackpot, step 66, which are here 6. If he does not do that, one value unit is taken from the group credit as a stake, which here includes 4 value units. The calculating unit 42 receives a selection of all value units if the player presses the fourth button 18 and a selection of one value unit if he presses the fifth button 20. If the user pressed the fifth button, i.e. did not select all value units in the group jackpot, step 66, the calculating unit orders the display 12 to present the third card 28 to the user so that he can see its value or level, step 68. If the third card 28 has a level or value that is in-between the levels or values of the first 26 and the second 30 cards, step 70, the stake is doubled, step 72, i.e. the group credit is increased with a value of one so that it now corresponds to 5 value units. Two value units are thereafter possibly transferred over to the third group winnings that is shown in the third field 34 that corresponds to the winnings of the game. However, if the third card did not have a value between the first and second card, step 70, the stake is removed, step 74, i.e. the group credit is decreased by one, so that it now has the value of 3. Thereafter, independently of if the stake was doubled, step 72, or removed, step 74, the method continues with decreasing the value of the counter by 1, step 76, and thereafter goes back to step 58 with drawing first, second and third cards.

If on the other hand the user selected all value units, step 66, then once again the third card is presented, step 78, and a comparison is made in order to see if it lies in-between the first and the second card, step 80. If the third card 28 lies in-between the first and the second card, step 80, the stake is doubled, step 82, which means that the first group jackpot that is shown in the first field 32 receives 6 value units and would after this include 12 value units. Thereafter the user is offered to save his winnings, step 86, through transferring all but 6 value units in the first group jackpot to the third group winnings. If the user selects to do this, by pressing the third button 16, then all value units but 6 are transferred to the third group winnings, step 88, which in this example thus would include 6 value units and the group jackpot would also include 6 units. Thereafter the method returns and sets the counter to 5, step 56. If the user does not want to save his winnings, step 86, he is offered to continue playing, step 90. However, if the card in step 80 was not in-between the first and the second card, the stake is removed, step, 84, which in this example means that the first group jackpot would now include zero value units. Thereafter the user is offered to continue playing, step 90. If the user here selects to stop playing, step 90, the calculating unit 42 sends a signal to the unit 43, corresponding to value units that are left in all groups, i.e. the groups jackpot, winnings and credit. This signal makes a coin box provided in the unit 42 to emit coins corresponding to the value of the value units to the value unit returner 24. In this way possible electronic value units are thus converted to physical value units and the physicals value units are paid out, step 94.

If the player now selects to continue playing, step 90, it is first investigated if the value units are finished, step 92, i.e. if there are enough value units left for playing a new round. If they are finished, step 92, the player is offered to enter more value units and the method returns to receiving value units, step 50 and the game continues. If the user had enough value units, step 92, the method continues with setting the counter to 5, step 56, and the user can continue playing. The choice to save some of the winnings in step 86 is chosen through the user pressing the third button 16. The first button 14 entails a user selection of the winnings or remaining value units to be paid out and the second button 15 entails a user selection to continue playing without transferring value units in his jackpot to the group winnings. The third and the second button can be depressed in step 86. When these selections are performed in step 86, this also means that the user automatically selects to continue playing in step 90. The first button can either be selected in connection with winning in step 82, when the button is depressed in step 86, which automatically entails a choice of not continuing playing in step 90. When there is no winning via step 84, the user may select to depress the first or the second button in step 90, where depressing the first button entails a selection to stop playing and depressing the second button entails a selection to continue playing.

If the user earlier selected to bet the lowest stake, i.e. not to play his jackpot the whole four times in a row, the counter has received the value 1. When the first and second cards then have been presented to the user, step 60, the counter value is thus 1 that corresponds to a second pre-determined value for the counter, step 62. At this point the calculating unit automatically selects all the value units in the group jackpot, step 64. At this point, the user does thus not have any choice and has to play his jackpot. Thereafter the method continues in the steps 78, 80 etc. in the earlier described manner. In the game new cards are drawn from the virtual deck of cards as long as there are any remaining and as long as the player wants to continue. If all cards are used during a game, the virtual deck is reshuffled and new cards are again randomly drawn.

With the above described invention there is thus provided a game, where a user gets a reasonable chance to value his stakes and when to select to play his jackpot while at the same time ensuring that the game operator receives a reliable profit margin. The game is furthermore very simple in its construction and can thus be immediately grasped by the user without any complicated learning measures.

In the game outlined above there are a number of further details to be described. As mentioned before, the game includes a joker. Such a card can only appear as the third card and not as the first and second card. This comparison value can then only be selected as the third card. The calculating unit thus excludes this value from the random selection of the first and the second comparison value, but includes it at the random selection of the third comparison value. This card has a varying level and is always deemed to lie between two cards, i.e. even if the first and the second card have the same value this card implies that there is still a chance to win despite this fact. Another detail that needs to be mentioned is that in the game described above, the value units of one group can run out. In this case value units are taken from another group. If for instance the group credits is empty, then value units are taken from the group winnings. Is also the group winnings empty, then value units are taken from the group jackpot. There has furthermore always to be value units present in one of the groups in order for the player to be allowed to play. In the present preferred embodiment there is furthermore a requirement of a number of value units in the group jackpot. In this embodiment there are 6 value units that have to be present there in order to be allowed to start playing.

There are a number of variations that are possible to implement in the game described above. The game does not have to be the actual game described above, but the invention can just as well be provided in relation to other games, such as for example poker. The different values and the distribution of value units that have been described are furthermore only exemplary and it should be realized that it is possible to receive more or fewer value units and also allow the counter to count more or fewer times than five. It is also possible to start and stop counting at other values. It is furthermore possible to make the counter count upwards instead of downwards. It is furthermore possible to provide the device with some form of sound function that emits a sound, for instance in the form of one or more bell tolls, when the user is winning when wagering his jackpot.

The invention can also be realized as a computer program product, for instance a CD-ROM disc comprising program code, which performs the invention when being loaded into a computer. Such a disc 94 is schematically shown in FIG. 5. This program code can also be provided in some other form, for instance on another type of storage medium. It is also possible that this programs code is stored on a server and downloaded to a computer for instance via the Internet.

1. Method of generating a signal corresponding to at least one value unit in relation to a performed comparison of a number of comparison values comprising the steps of:
receiving an input signal corresponding to a number of value units from a user,
distributing the value units into at least a first and a second group,
setting a first pre-determined counter value,
performing comparison value dependent calculations, and
generating an output signal to the user corresponding to obtained value units in dependence of the result in said step of performing comparison value dependent calculations,
wherein the step of performing comparisons value dependent calculations comprises the further steps of:
receiving a selection of all the value units in said first group or one value unit primarily from the second group,
comparing at least two comparison values with each other, and
increasing the number of value units in said first group if the user has selected the value units therein or of the value units in another group if the user has selected one value unit, in case the comparison is in favor of the user, or
removing all selected value units in case the comparison is not in favor of the user,
wherein the method furthermore comprises the further steps:
repeating the step of performing comparison value dependent calculations,
changing the counter value each time the step of comparison value dependent calculations is performed for only one value unit and otherwise resetting said counter value, and
automatically selecting all value units in said first group in the step of performing comparison value dependent calculations if the counter value has reached a second pre-determined counter value.

2. Method according to claim 1, further comprising, in the step of performing comparison value dependent calculations, the steps of:
randomly selecting three comparison values out of a set of a pre-determined number of fixed comparison values,
ordering the presenting of two of the comparison values to the user,
wherein the step of comparing is performed through comparing the third comparison value with the two presented comparison values, and the comparison is in favor of the user if the third comparison value is in-between said two first mentioned comparison values and the comparison is not in favor of the user if the third comparison value in the comparison is not in-between said two comparison values.

3. Method according to claim 1, wherein the user is offered reception of value units after performing the step comparison value dependent calculations when all value units in the first group have been selected and the step of generating an output signal comprises generating an output signal that corresponds to all remaining value units of all groups.

4. Method according to claim 1, wherein the step of performing comparison value dependent calculations is only allowed as long as any group comprises value units.

5. Method according to claim 1, wherein the step of performing comparison value dependent calculations is only allowed if the first group includes at least a predetermined number of value units.

6. Method according to claim 1, further comprising the steps of offering the user to transfer value units to a third group after increasing the number of value units in the first group, and transferring value units to this third group.

7. Method according claim 1, wherein by a selection of only one value unit in the step of performing comparison value dependent calculations, the value unit is primarily selected from the second group, thereafter from a possible third group and ultimately from the first group in dependence of availability of value units in the different groups.

8. Method according to claim 2, wherein one of the comparison values can only be present for selection as the third comparison value and has a varying value that is always deemed to lie between the first and second selected comparison values.

9. Method according to claim 1, wherein the set of comparison values has a number of discrete levels, where at least four different comparison values are provided at each level and comparison values on the same level have the same value.

10. Device for generating a signal corresponding to at least one value unit in relation to a performed comparison of a number of comparison values comprising:
an input unit for receiving an input signal corresponding to a number of value units from a user,
an output unit for generating an output signal to the user corresponding to a number of obtained value units in dependence of comparison value dependent calculations, and
a calculating unit for distributing the value units into at least a first and a second group, for setting a first pre-determined counter value and for performing comparison value dependent calculations,
which, when performing comparison value dependent calculations, is arranged to:
receive a selection of all the value units in said first group or one value unit primarily from the second group,
compare at least two comparison values with each other, and
increase the number of value units in said first group if the user has selected the value units therein or of value units in another group if the user has selected one value unit in case the comparison is in favor of the user, or
remove all selected value units in case the comparison is not in favor of the user
wherein said calculating unit is further arranged to:
repeat the performing of comparison value dependent calculations,
change the counter value each time comparison value dependent calculations are performed for only one value unit and otherwise reset said first pre-determined counter value, and
automatically select all value units in the first group when performing comparison value dependent calculations if the counter value has reached a second pre-determined counter value.

11. Device according to claim 10, wherein said calculating unit is further arranged to:
randomly select three comparison values out of a set of a pre-determined number of fixed comparison values,
order the presenting of two of the comparison values to the user,
compare the third comparison value with the two presented comparison values,
wherein the comparison is in favor of the user if the third comparison value is in-between said two first mentioned comparison values and the comparison is not in favor of the user if the third comparison value in the comparison is not in-between said two comparison values.

12. Device according to claim 10, wherein the calculating unit offers the user reception of value units after performing comparison value dependent calculations when all value units in the first group have been selected and the output unit is further arranged to generate, when generating an output signal, an output signal that corresponds to all remaining value units of all groups.

13. Computer program product for generating a signal corresponding to at least one value unit in relation to a performed comparison of a number of comparison values, comprising computer program code for, when said code is loaded into a computer, make said computer do:
enable reception of an input signal corresponding to a number of value units from a user,
distribute the value units into at least a first and a second group,
set a first pre-determined counter value,
perform comparison value dependent calculations, and
generate an output signal to the user corresponding to a number of obtained value units in dependence of the result in said performing of comparison value dependent calculations,
wherein said computer when performing said comparison value dependent calculations causes:
enabling reception of a selection of all the value units in said first group or one value unit primarily from the second group,
comparing at least two comparison values with each other, and
increasing the number of value units in said first group if the user has selected the value units therein or the value units in another group if the user has selected one value unit in case the comparison is in favor of the user, or
removing all selected value units in case the comparison is not in favor of the user,
wherein said computer when performing comparisons value dependent calculations furthermore causes:
repeating the performing of comparison value dependent calculations, changing the counter value each time the comparison value dependent calculations are performed for only one value unit, and otherwise resetting said first pre-determined counter value, and
automatically selecting all value units in said first group when performing comparison value dependent calculations if the counter value has reached a second pre-determined counter value.

14. A game comprising:
an input unit for receiving an input signal corresponding to a number of value units from a user,
an output unit for generating an output signal to the user corresponding to a number of obtained value units in dependence of comparison value dependent calculations, and
a calculating unit for distributing the value units into at least a first and a second group, for setting a first pre-determined counter value and for performing comparison value dependent calculations,
which, when performing comparison value dependent calculations is arranged to:
receive a selection of all the value units in said first group or one value unit primarily from the second group,
compare at least two comparison values with each other, and increase the number of value units in said first group if the user has selected the value units therein or of value units in another group if the user has selected one value unit in case the comparison is in favor of the user, or
remove all selected value units in case the comparison is not in favor of the user
wherein said calculating unit is further arranged to:
repeat the performing of comparison value dependent calculations, change the counter value each time comparison value dependent calculations are performed for only one value unit and otherwise reset said first pre-determined counter value, and
automatically select all value units in the first group when performing comparison value dependent calculations if the counter value has reached a second pre-determined counter value.
